(19) United States
(12) Patent Application Publication
(10) Pub. No.: US 2004/0119588 A1
(43) Pub. Date: Jun. 24, 2004

(54) Door mountable alarm system

(76) Inventor: Roger Julian Marks, Bedford (GB)

Correspondence Address: HESLIN ROTHENBERG FARLEY & MESITI PC, 5 COLUMBIA CIRCLE, ALBANY, NY, 12203, US

(21) Appl. No.: 10/693,312

(22) Filed: Oct. 24, 2003

Related U.S. Application Data
(63) Continuation of application No. PCT/GB02/01947, filed on Apr. 29, 2002.

(30) Foreign Application Priority Data
May 2, 2001 (GB) 0110759.8

(51) Int. Cl. G08B 1/08

(52) U.S. Cl. 340/539.1

(57) ABSTRACT

An alarm system includes a sensor/control unit and an antenna unit, each mounted to a support member which may be disposed around an edge of a door of a container or the like, with the antenna unit outside the door and the sensor/control unit inside the door. Clamps are provided to hold the system to the door. The system may thus be removed and transferred to another container as desired. The sensor/control unit contains a radio transmitter, which transmits data via the antenna unit to a remote receiver. The sensor/control unit may also contain an alarm against unauthorized entry or tampering, a tracking system, and/or telemetry sensors to monitor the interior of the container, for example for cargo condition, temperature, or illicit contents, such as contraband or stowaways.

### CROSS REFERENCE TO RELATED APPLICATIONS

This application is a continuation of international application PCT/GB02/01947 filed Apr. 29, 2002 and published in English as WO 02/089084 A1 on Nov. 7, 2002, and claims priority from United Kingdom application GB 0110759.8 filed May 2, 2001, which applications are incorporated by reference in full herein.

The present invention relates to an alarm system. More particularly but not exclusively, it relates to an alarm and monitoring system, especially for transport containers and the like which may be used on any standard container without requiring modification thereof.

Radio or other telemetry systems are frequently used to track vehicles, and to secure vehicles against theft or damage. In some cases, it may be cost effective to install security equipment permanently. However, this is not always feasible for containers given their wide range of use and indeed of user. It would, however be more convenient and commercially more attractive to use portable, self-contained alarm and tracking systems, which could be transferred between containers and the like as required.

For maximum security, as much as possible of such a system should be inaccessible from outside the container. However, containers usually comprise substantially complete metal enclosures, which does not permit radio transmission. Hence an aerial mounted external to the container would be necessary for a system to transmit, or receive, data by radio.

Containers and the like are usually exposed to the elements, and are often transported by sea, so need to be substantially weatherproof and watertight. It is therefore inappropriate, for example, to cut apertures in a wall of a container through which to run connecting wires between an externally-mounted aerial and an alarm package within the container. A system would ideally require no modification of a container or the like to which it was to be mounted, and should not compromise the integrity thereof.

As well as an alarm and tracking system, it could also be beneficial to monitor the condition of freight within a container, particularly when dealing with perishable or hazardous cargoes. It could further be beneficial to monitor the container for signs of unauthorised cargoes, such as contraband materials, or even stowaways.

While the above problems are particularly relevant to conventional freight containers, similar problems may be experienced with articulated lorry trailers, with other enclosed lorries and vans, and with railway rolling stock, such as goods vans (boxcars). A system for such applications would also be usable on portable buildings, site huts, temporary storage facilities and the like, even where they do not form a complete Faraday cage preventing radio transmission or reception.

Therefore, although the invention will be described hereinafter mainly in terms of conventional freight containers, the term “container” should be understood to include trailers, lorries, vans, rolling stock, portable buildings and so forth as listed above.

It is therefore an object of the present invention to provide an alarm system, detachably mountable to a container as defined herein without modification of the container, which obviates the problems referred to above, protecting the alarm from tampering while allowing unrestricted radio communication therewith.

According to the present invention, there is provided an alarm system detachably mountable to a door means of a container, as herein defined, comprising support means disposable around an edge of the door means, antenna means mounted to the support means and adapted to be disposable exterior of the container, and sensor/control means, including radio communication means, operatively linked to the antenna means and so mounted to the support means as to be locatable interior of the container.

The sensor/control means may be operatively linked to the antenna means by electromagnetic induction through the door means.

Alternatively, the sensor/control means may be operatively linked to the antenna means via the support means.

In this case, the sensor/control means may be operatively linked to the antenna means by fibre optic or electrical cable means, either mounted to or enclosed within the support means.

The support means may comprise a generally U-shaped support member, optionally of steel, the antenna means being mounted to a first arm of the U-shape and the sensor/control means being mounted to a second arm thereof.

The support means may then be disposable around an edge of the door means with a basal portion, optionally flattened, of the U shape adjacent the edge of the door means, the first arm carrying the antenna means adjacent an external surface of the door means and the second arm carrying the sensor/control means adjacent an internal surface of the door.

The alarm system may be provided with clamp means to attach it detachably to the door means.

Said clamp means may optionally comprise the support means.

The clamp means may comprise detent means adapted to engage with an external surface of the door means.

Preferably, the antenna means is adapted to transmit signals from the sensor/control means to a receiver means remote from the container.

Advantageously, the antenna means is adapted to receive signals, optionally controlling signals.

The sensor/control means preferably comprises alarm means, adapted to respond to an attempt to gain access to the container, such as an attempt to open the door means.

The alarm system may advantageously be adapted to respond to an attempt to interfere with the alarm system itself, including the antenna means.

Optionally, the antenna means is so adapted that forcible removal thereof will leave a residual antenna element linked to the sensor/control means and sufficient to transmit an alarm signal.

The sensor means may further comprise tracking means adapted to determine the location of the container, optionally by means of a receiver of satellite positioning information, such as GPS (Global Positioning System).

The sensor means may comprise monitoring means, adapted to monitor selected conditions interior of the container.

Said monitoring means may be adapted to sense physical parameters, such as temperature, within the container.

The sensor means may then be adapted to monitor the temperature within a chilled or refrigerated container and to signal the control means to transmit an alerting signal when said temperature exceeds predetermined bounds.

Said monitoring means may comprise chemical detector means, adapted to detect and optionally qualify and/or quantify particular gases and/or vapours within the container.

Said gases and/or vapours may optionally comprise carbon dioxide, so that respiration and/or combustion within the container may be detected.

Said gases and/or vapours may optionally comprise those given off by perishable cargoes, such as ripening fruit.

Said gases and/or vapours may optionally comprise those given off by potentially contraband substances, such as explosives or narcotics.

Said gases and/or vapours may optionally comprise flammable or noxious vapours that may be released by leaking cargoes.

The monitoring means may optionally comprise radiation detector means.

The monitoring means may be adapted to detect movement of goods or people within the container.

The monitoring means may comprise active or passive infrared or ultrasonic motion detection means.

The monitoring means may additionally or alternatively comprise vibration detection means.

The vibration detection means may be adapted to distinguish vibrations characteristic of attempted forced entry to the container or interference with the support means or the antenna means, such as those from hammering or the action of drills, angle grinders and other powered tools.

The system may be provided with arming means activated by closure of the container.

Said arming means may comprise mechanical contact switches or proximity sensors, such as infrared, ultrasonic or capacitative proximity sensors.

The system may alternatively or additionally be armed by means of radio signals from a transmitter source external of the container, for example in the cab of a lorry carrying the container.

The system may alternatively be connected physically to an arming command means external of the container, for example by electrical, fibre-optic or mechanical connections.

Embodiments of the present invention will now be more particularly described, by way of example and with reference to the Figures of the accompanying drawings, in which:

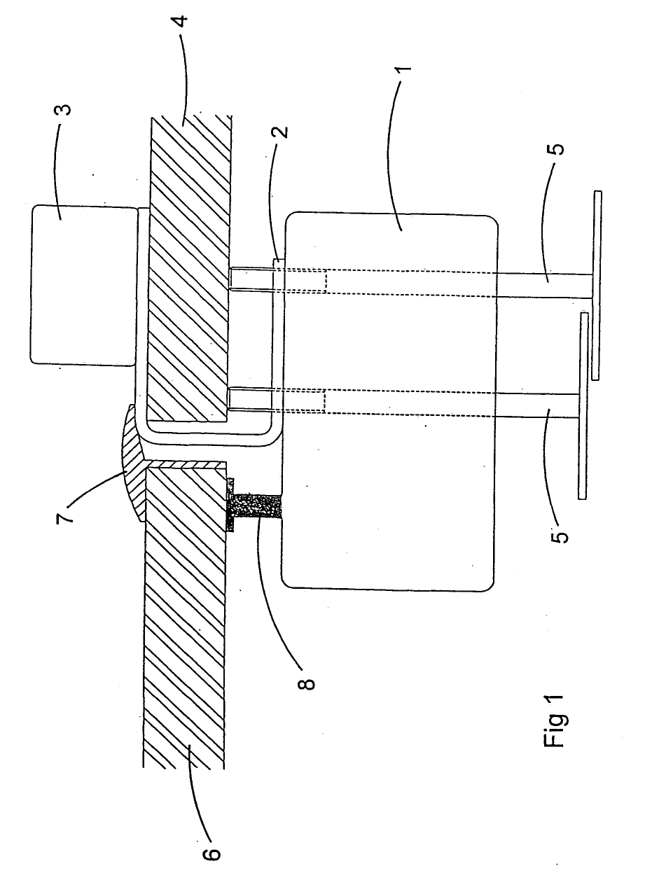

FIG. 1 shows in plan view from above an alarm system embodying the invention in position on a door of a container;

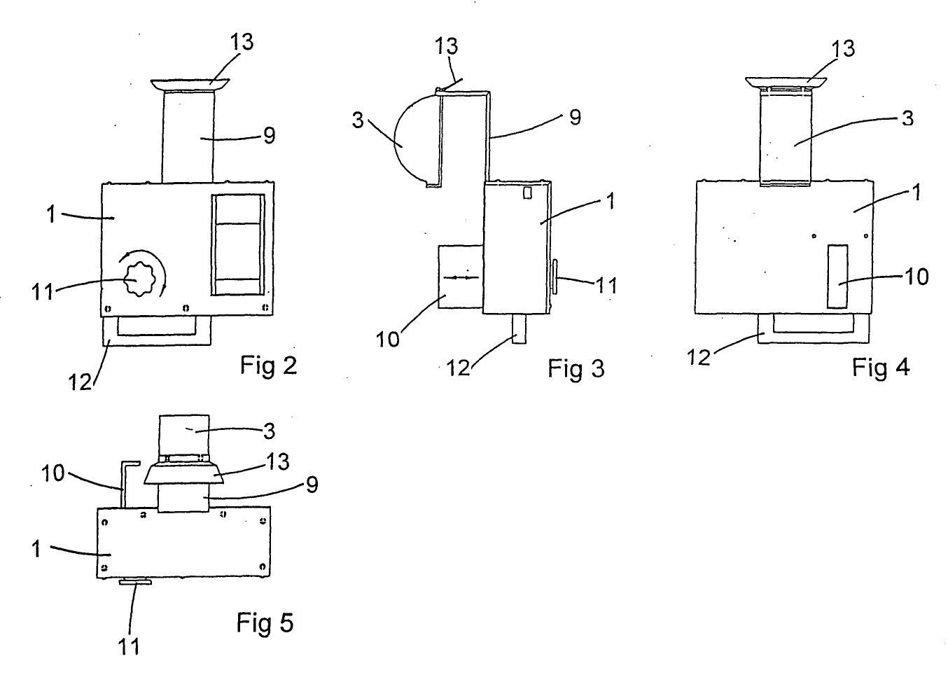

FIG. 2 is an elevation of an alternative embodiment of the invention, viewed from a side interior, in use, of the container;

FIG. 3 is a side elevation of the system of FIG. 2;

FIG. 4 is an elevation of the system of FIG. 2, viewed from a side opposite to that of FIG. 2; and

FIG. 5 is a plan view of the system of FIG. 2.

Referring now to the drawings, and to FIG. 1 in particular, an alarm system for a container comprises a sensor and control unit 1, mounted to one arm of a generally U-shaped steel clamp member 2, and an antenna unit 3 mounted to the other arm of the clamp member 2. The clamp member 2 is disposable around an edge of a first door 4 of a container, and two clamp screws 5 are provided by which the sensor system may be securely but detachably attached to the first door 4. The first door 4 may then be closed, followed by a second door 6 of the container, the U-shaped clamp member 2 extending through a gap between the two doors 4, 6 and a sealing strip 7 mounted along an edge of the second door 6. The sealing strip 7 generally comprises a flexible material, such as a natural or synthetic rubber, and so forms a weathertight seal around the clamp member 2.

The sensor and control unit 1 comprises a self-contained power supply, a radio transmitter/receiver unit and any or all of a range of sensors. For example, the unit 1 may comprise an alarm against unauthorised entry or tampering. This may comprise physical contact or proximity sensors (e.g. infrared, ultrasonic or capacitance sensors) to indicate unauthorised opening of the doors, and/or may comprise vibration sensors, optionally provided with discrimination circuitry to distinguish vibrations due to the use of angle-grinders, drills and the like in an attempt to gain entry to the container or to tamper with any part of the alarm system.

The control unit 1 may also comprise a tracking unit, which may conveniently include a receiver for satellite location signals, such as GPS (Global Positioning System), either to track the container if it is stolen or as part of a continuously-operating stock-keeping system.

In certain applications, a range of telemetry systems may also be included in the sensor and control unit 1. For example, carbon dioxide sensors could register and report the presence of stowaways or combustion within the container. Detectors for other gases and vapours could be used to monitor the condition of perishable goods, such as fruit; could watch for leaks of flammable solvents or other hazardous cargoes; or could detect the presence of illicitly transported materials such as drugs or explosives. Temperature sensors could monitor the temperature within a refrigerated container or the like, and transmit an alert if its interior becomes too warm (e.g. should there be a failure of a refrigeration unit on a refrigerated trailer). Radiation sensors could alert to an attempt to smuggle nuclear materials, and appropriate sensors could be deployed to monitor for the presence of microbiological materials, either accidentally or maliciously present. Passive infrared or other motion sensors could also be deployed to detect stowaways within a container or the like.

The external unit 3 may communicate with the sensor and control unit 1 by induction through the metal of the door 4, or via electrical or fibre optic cabling, which may be routed within or adjacent to the U-shaped clamp member 2, so that it can easily pass between the doors 4, 6 and around the sealing strip 7.

The system may be controlled by remote signals via the antenna unit 3, or may additionally or alternatively be armed via a contact switch 8 mounted to the sensor and control unit 1, and disposed to contact the second door 6 of the container in a closed disposition thereof. The mechanical contact switch 8 shown may in other embodiments be replaced by proximity sensors of conventional type, such as ultrasonic, infrared or capacitative sensors.

The system may also be set or controlled by signals sent by wire, optical fibre or remotely from the cab of a lorry carrying the container.

Further conventional security devices, such as arming keys, code keypads, audible alarms, smoke or dye bombs and the like may also be incorporated into the system, if desired, preferably mounted to the sensor and control unit 1 for concealment in use.

Should an attempt be made to disable the system by removing the antenna unit 3, for example by knocking it off with a sledgehammer, sufficient of the aerial of the antenna unit 3 will remain to transmit a simple emergency alarm signal. A further contact switch or proximity sensor may be mounted to or adjacent the antenna unit 3, adapted to set off the alarm if the antenna unit 3 is separated from the door 4. The vibration sensors referred to above may be adapted to register vibrations caused by an attack on the clamp member 2, for example with a drill or other power tool, and activate the alarm accordingly.

An alternative form of alarm system is shown in FIGS. 2 to 5, in which the single U-shaped clamp member 2 shown in FIG. 1 is replaced by separate support and fastening devices.

The sensor and control unit 1, as described above, is connected to an antenna unit 3 (here shown with a generally hemicylindrical housing) by a generally U-shaped hook member 9, adapted to be hooked over an upper edge of a door (not shown), thereby supporting the system on the door. An L-shaped clamp arm 10 extends from a face of the sensor and control unit 1 oriented, in use, towards the door. The clamp arm 10 is adapted to extend through a gap adjacent a side of the door and past a sealing strip 8 and to engage with an outer face of the door. Rotation of a knob 11 operatively connected to the clamp arm 10 draws the clamp arm 10 back towards the unit 1, clamping the alarm system firmly to the door.

The antenna unit 3 may be connected operatively to the sensor and control unit 1 by induction or by direct wiring, as described above. A handle 12 is provided to facilitate carrying and fitting the system.

In another embodiment of the invention, the antenna unit 3 may be mounted to the clamp arm 10 instead of to the hook member 9.

In this case, a contact flap 13 may be provided, mounted to an upper portion of the hook member 9. When a door supporting the system is closed, the seal 7 in the area of the hook member 9 may be deformed to leave a void. The contact flap 13 is adapted to fill any such void in the seal 7 and prevent ingress of moisture.

The alarm system of FIGS. 2 to 5 is particularly suitable where use on a range of doors of differing thicknesses is envisaged.

The alarm systems described will provide a reliable, secure alarm, tracking and/or telemetry system which may be transferred from one container to another as desired. They are self-contained, and require no modifications to the container on which they are used—in particular, there is no need to cut apertures in the container for antenna connections, which could otherwise compromise its integrity.

1. An alarm system detachably mountable to a door means of a container, comprising support means disposable around an edge of the door means, antenna means mounted to the support means and adapted to be disposable exterior of the container, and sensor/control means, including radio communication means, operatively linked to the antenna means and mounted to the support means to be disposable interior of the container.

2. An alarm system as claimed in claim 1, wherein the sensor/control means is operatively linked to the antenna means by electromagnetic induction through the door means.

3. An alarm system as claimed in claim 1, wherein the sensor/control means is operatively linked to the antenna means via the support means.

4. An alarm system as claimed in claim 3, wherein the sensor/control means is operatively linked to the antenna means by electrical or fiber optic cable means, mounted to or enclosed within the support means.

5. An alarm system as claimed in claim 1, wherein the support means comprises a generally U-shaped support member with the antenna means mounted to a first arm thereof and the sensor/control means mounted to a second arm thereof.

6. An alarm system as claimed in claim 1, further comprising clamp means to attach the support means detachably to the door means.

7. An alarm system as claimed in claim 1, wherein the sensor/control means comprises alarm means adapted to respond to an attempt to gain access to the container or to interfere with the alarm system, including the antenna means.

8. An alarm system as claimed in claim 1, wherein the sensor/control means further comprises tracking means.

9. An alarm system as claimed in claim 1, wherein the sensor/control means comprises means adapted to sense a physical parameter within the container.

10. An alarm system as claimed in claim 1, wherein the sensor/control means comprises chemical detector means adapted to detect gases and/or vapors within the container.

11. An alarm system as claimed in claim 1, wherein the sensor/control means comprises means adapted to detect movement of goods or people within the container.

12. An alarm system as claimed in claim 1, wherein the sensor/control means comprises vibration detection means.

13. An alarm system as claimed in claim 1, provided with arming means activated by closure of the container.

14. An alarm system as claimed in claim 9, wherein said physical parameter comprises temperature.

15. An alarm system as claimed in claim 10, wherein said chemical detector means quantifies said gases and/or vapors within the container.

16. An alarm system as claimed in claim 10, wherein said gases and/or vapors comprise carbon dioxide, gases and/or vapors given off by perishable cargos, explosives or narcotics, and/or flammable or noxious vapors.

17. An alarm system as claimed in claim 12, wherein said vibration detector means distinguishes vibrations characteristic of attempted forced entry into the container and/or interference with the support means or the antenna means.
